(19) United States
(12) Patent Application Publication
(10) Pub. No.: US 2003/0190163 A1
(43) Pub. Date: Oct. 9, 2003

(54) Observation optical device with photographing function

(75) Inventors: Ken Hirunuma, Tokyo (JP); Shigeo Enomoto, Tokyo (JP); Atsumi Kaneko, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/407,224

(22) Filed: Apr. 7, 2003

(30) Foreign Application Priority Data
Apr. 9, 2002 (JP) P2002-106388

(51) Int. Cl. G03B 13/00

(52) U.S. Cl. 396/125

(57) ABSTRACT

An observation optical device with a photographing function comprises a photographing optical system, a telescopic optical system, and a solid-state imaging device disposed on the optical axis of the photographing optical system. The photographing optical system forms an image. The telescopic optical system can function as a viewfinder optical system for the photographing optical system. The solid-state imaging device photoelectrically converts the image into an image signal, and outputs the image signal in the progressive-scan method.

### BACKGROUND OF THE INVENTION

1. Field of the Invention

The present invention relates to an observation optical device with a photographing function, in which a photographing optical system is mounted.

2. Description of the Related Art

As is well known, an observation optical device, such as a binocular telescope or a monocular telescope, is used for watching sports, wild birds, and so on. When using such a binocular telescope, it is often the case that the user sees something that he or she would like to photograph. Typically, he or she will fail to photograph the desired scene because he or she must change a camera for the binocular telescope and during this time the chance is lost. For this reason, a binocular telescope containing a camera is proposed, whereby a photograph can be taken immediately by using the camera contained in the binocular telescope while continuing the observation through the binocular telescope.

For example, Japanese Laid-Open Utility Model Publication (KOKAI) No. 6-2330 discloses a binocular telescope with a photographing function, i.e., a combination of a binocular telescope and a camera, in which the camera is simply mounted in the binocular telescope. The binocular telescope is provided with a pair of telescopic optical systems for observing an observed object in an enlarged state, and a photographing optical system for photographing the observed object. The pair of telescopic optical systems functions not only as a viewfinder optical system for the photographing optical system, but also as a telescopic binocular system. Note that the above described Japanese Publication does not disclose whether the camera uses a silver-halide film or a solid-state imaging device as a recording medium.

U.S. Pat. No. 4,067,027 discloses another type of binocular telescope with a photographing function, which is provided with a pair of telescopic optical systems and a photographing optical system. Similarly to the above, the pair of telescopic optical systems functions not only as a viewfinder optical system for the photographing optical system, but also as a telescopic binocular system. The binocular telescope with a photographing function described in the USP has a camera using a silver halide film as a recording medium.

When an observation optical device with a photographing function is designed in such a manner that a digital camera, using a solid-state imaging device such as a CCD, is assembled in a telescopic optical device such as a binocular telescope or a monocular telescope, there are various problems to be solved. First of all, when a telescopic optical device is provided with a photographing function, a camera shake easily happens due to the increased weight, and therefore a design which prevents image deterioration because of the camera shake is required. Secondly, because ease of portablility of the observation optical device with a photographing function is important, it is necessary for the whole structure of the telescopic optical device to be compact and light weight, and because economization is important, the manufacturing and assembling cost of the telescopic optical device has to be reduced as much as possible.

### SUMMARY OF THE INVENTION

Therefore, an object of the present invention is to provide an observation optical device with a photographing function, in which deterioration of the photographed image generated by a camera shake hardly occurs, and where the whole structure is not only compact and light weight, but also the manufacturing and assembling costs are reduced as much as possible.

According to the present invention, there is provided an observation optical device with a photographing function, comprising a photographing optical system, a telephoto observation optical system, and a solid-state imaging device.

The photographing optical system forms an image. The telephoto observation optical system can function as a viewfinder optical system for the photographing optical system. The solid-state imaging device photoelectrically converts the image into an image signal, and outputs the image signal in the progressive-scan method.

Preferably, the telephoto observation optical system has a first part fixed at a predetermined position, and a second part movable along the optical axis of the telephoto observation optical system relative to the first part so that the telephoto observation optical system focuses. A rotary wheel cylinder, in which the photographing optical system is mounted, is disposed close to the telephoto observation optical system. A first focusing mechanism for converting a rotational movement of the rotary wheel cylinder into a linear movement of the second part so that the telephoto observation optical system focuses, is provided between the rotary wheel cylinder and the second part. A second focusing mechanism for converting a rotational movement of the rotary wheel cylinder into a linear movement of the photographing optical system so that the photographing optical system focuses on the solid-state imaging device, is provided between the rotary wheel cylinder and the photographing optical system.

The telephoto observation optical system may comprise a pair of telescopic optical systems. The rotary wheel cylinder is provided between the pair of telescopic optical systems. The observation optical device may further comprise a casing in which the pair of telescopic optical systems is housed. The casing has first and second casing sections which are movable relative to each other. One of the pair of telescopic optical systems is housed in the first casing section. Another of the pair of telescopic optical systems is housed in the second casing section. One of the first and second casing sections is moved relative to another of the first and second casing sections, so that the interpupillary distance is adjusted.

Preferably, one of the first and second casing sections is slidably housed in another of the first and second casing sections. The first and second casing sections are moved relative to each other so that the optical axes of the pair of telescopic optical systems are moved in a common plane to adjust the interpupillary distance.

### BRIEF DESCRIPTION OF THE DRAWINGS

The objects and advantages of the present invention will be better understood from the following description, with reference to the accompanying drawings in which:

FIG. 1 is a horizontal sectional view showing an embodiment of an observation optical device with a photographing function according to the present invention, in a state in which a movable casing section is set at a retracted position;

FIG. 2 is a sectional view along line II-II of FIG. 1;

FIG. 3 is a horizontal sectional view similar to FIG. 1, the movable casing section being set at a maximum-extended position;

FIG. 4 is a horizontal sectional view similar to FIG. 2, the movable casing section being set at a maximum-extended position;

FIG. 5 is a plan view showing an optical system mount plate provided in a casing of the optical device shown in FIG. 1;

FIG. 6 is a plan view showing right and left mount plates which are disposed on the optical system mount plate shown in FIG. 5;

FIG. 7 is an elevational view observed along line VII-VII of FIG. 6, in which the optical system mount plate is indicated as a sectional view along line VII-VII of FIG. 5;

FIG. 8 is an elevational view observed along line VIII-VIII of FIG. 1; and

FIG. 9 is a block diagram of a control circuit mounted on a control circuit board of the observation optical device with a photographing function.

### DESCRIPTION OF THE PREFERRED EMBODIMENTS

The present invention will be described below with reference to the embodiments shown in the drawings.

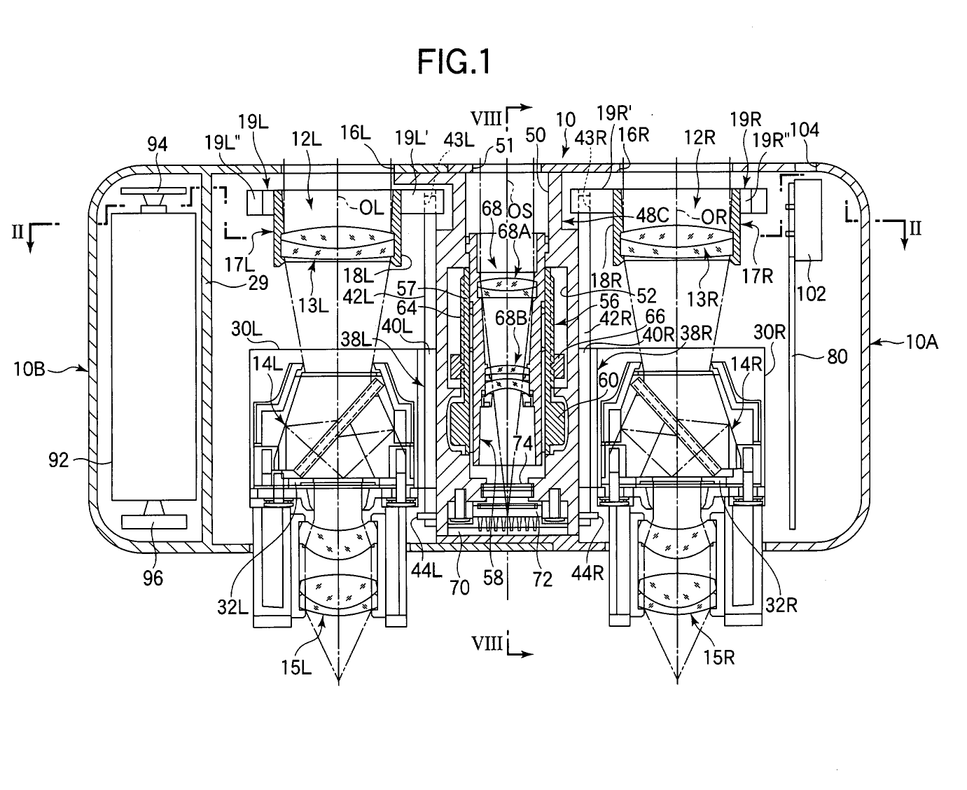

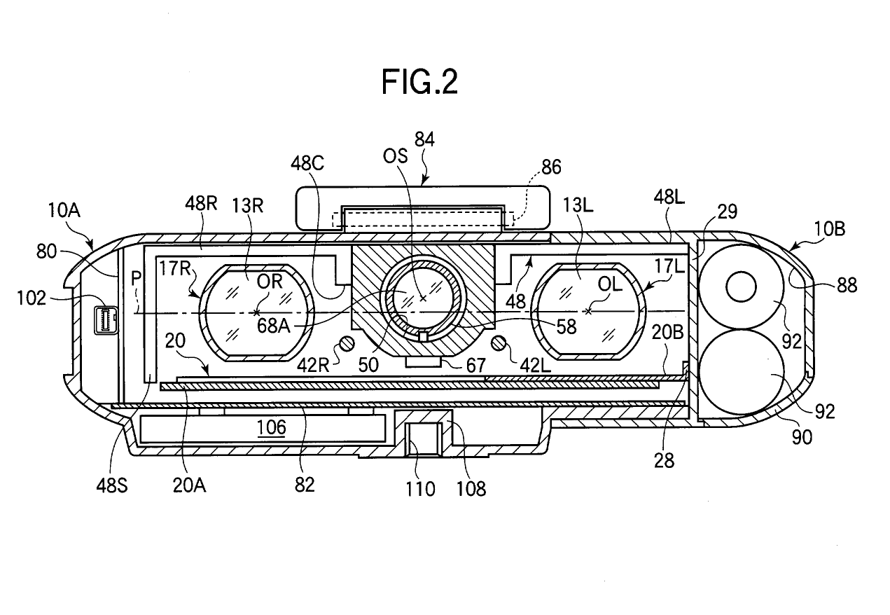

FIG. 1 shows an internal structure of an observation optical device with a photographing function, to which an embodiment of the present invention is applied, the observation optical device being a binocular telescope with a photographing function. FIG. 2 is a sectional view along line II-II of FIG. 1, and in FIG. 2, some elements are omitted so as to simplify the drawing. In the embodiment, the binocular telescope has a casing 10, which comprises a main casing section 10A and a movable casing section 10B.

A pair of telescopic optical systems 12R and 12L are provided in the casing 10. The telescopic optical systems 12R and 12L have a symmetrical structure, and are used for a right telescopic optical system and a left telescopic optical system. The right telescopic optical system 12R is mounted in the main casing section 10A, and contains an objective lens system 13R, an erecting prism system 14R, and an ocular lens system 15R. An observation window 16R is formed in a front wall of the main casing section 10A, and is aligned with the objective lens system 13R. The left telescopic optical system 12L is mounted in the movable casing section 10B, and contains an objective lens system 13L, an erecting prism system 14L, and an ocular lens system 15L. An observation window 16L is formed in a front wall of the movable casing section 10B, and is aligned with the objective lens system 13L.

Note that for simplicity of explanation, in the following description, front and back are respectively defined as a side of the objective lens system and a side of the ocular lens system, relative to the pair of telescopic optical systems 12R and 12L, and right and left are respectively defined as the right side and the left side when facing the ocular lens systems 15R and 15L.

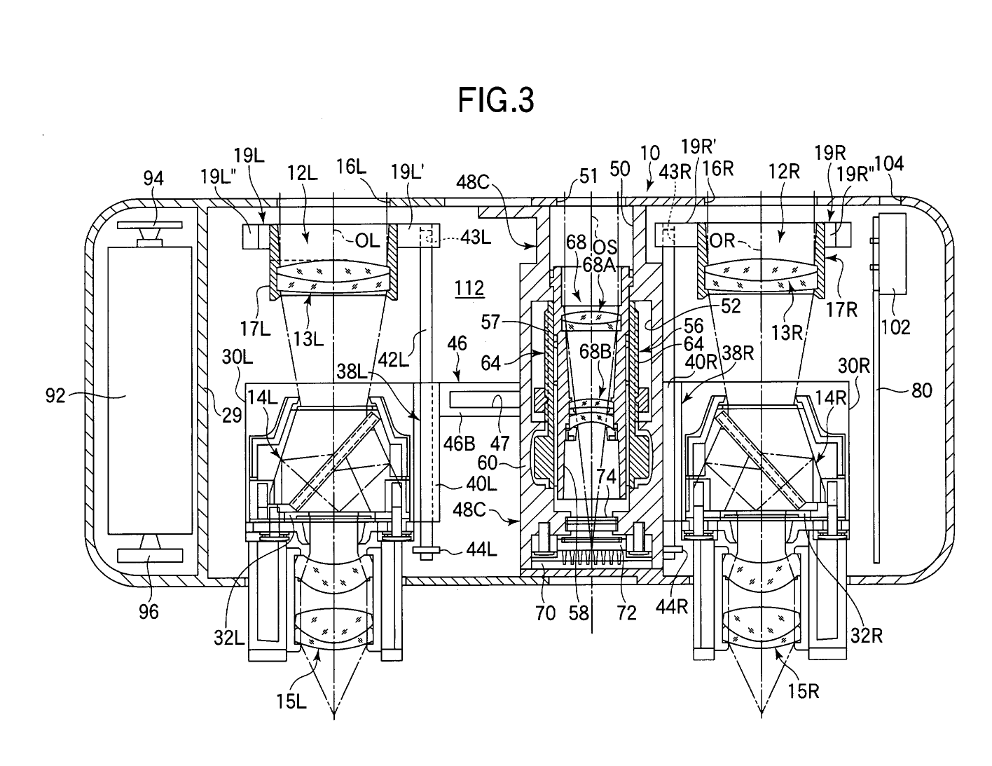

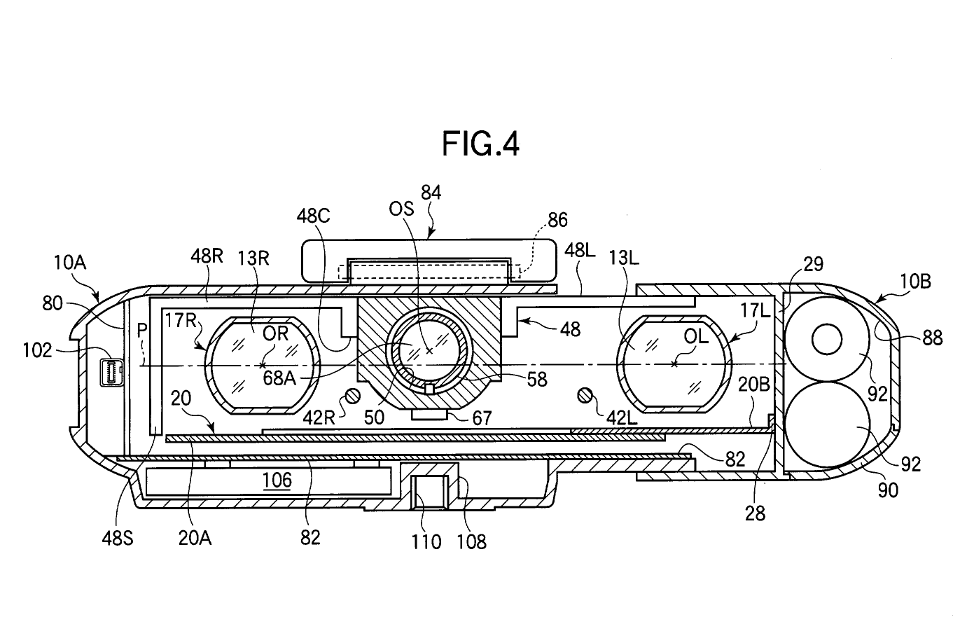

The movable casing section 10B is slidably engaged with the main casing section 10A such that the movable casing section 10B can be moved relative to the main casing section 10A. Namely, the movable casing section 10B is movable between a retracted position shown in FIGS. 1 and 2, and a maximum-extended position in which the movable casing section 10B is pulled out from the retracted position, shown in FIGS. 3 and 4. A suitable friction force acts on the sliding surfaces of both the casing sections 10A and 10B, and thus a certain extension or contraction force must be exerted on the movable casing section 10B before the movable casing section 10B can be extended from or contracted onto the main casing section 10A. Thus, it is possible for the movable casing section 10B to hold or stay still at an optical position between the fully retracted position (FIGS. 1 and 2) and the maximum-extended position (FIGS. 3 and 4), due to the suitable friction force acting on the sliding surface of both the casing sections 10A and 10B.

As understood from the comparison between FIGS. 1 and 2 and FIGS. 3 and 4, when the movable casing section 10B is pulled out from the main casing section 10A, the left telescopic optical system 12L is moved together with the movable casing section 10B, while the right telescopic optical system 12R is held in the main casing section 10A. Thus, by positioning the movable casing section 10B at an arbitrary extended position relative to the main casing section 10A, the distance between the optical axes of the ocular lens systems 15R and 15L, i.e., the interpupillary distance is adjusted. When the movable casing section 10B is set at the retracted position relative to the main casing section 10A, the distance between the telescopic optical systems 12R and 12L becomes the minimum (FIGS. 1 and 2), and when the movable casing section 10B is set at the maximum-extended position relative to the main casing section 10A, the distance between the telescopic optical systems 12R and 12L becomes the maximum (FIGS. 3 and 4).

The objective lens system 13R of the right telescopic optical system 12R is housed in a lens barrel 17R, which is mounted at a fixed position relative to the main casing section 10A, and the erecting prism system 14R and the ocular lens system 15R can be moved back and forth with respect to the objective lens system 13R, so that the right telescopic optical system 12R can be focused. Similarly, the objective lens system 13L of the left telescopic optical system 12L is housed in a lens barrel 17L, which is mounted at a fixed position relative to the movable casing section 10B, and the erecting prism system 14L and the ocular lens system 15L can be moved back and forth with respect to the objective lens system 13L, so that the left telescopic optical system 12L can be focused.

The lens barrel 17R has a cylindrical portion 18R, in which the objective lens system 13R is housed, and an attaching base 19R integrally formed under the cylindrical portion 18R. The attaching base 19R has an inside attaching portion 19R′ extending toward the center of the casing 10 from the cylindrical portion 18R, and an outside attaching portion 19R″ extending toward the outside of the casing 10 from the cylindrical portion 18R. The inside attaching portion 19R′ is a side block portion having a relatively large thickness, and the outside attaching portion 19R″ is a flat portion.

Similarly, the lens barrel 17L has a cylindrical portion 18L, in which the objective lens system 13L is housed, and an attaching base 19L integrally formed under the cylindrical portion 18L. The attaching base 19L has an inside attaching portion 19L′ extending toward the center of the casing 10 from the cylindrical portion 18L, and an outside attaching portion 19L″ extending toward the outside of the casing 10 from the cylindrical portion 18L. The inside attaching portion 19L′ is a side block portion having a relatively large thickness, and the outside attaching portion 19L″ is a flat portion.

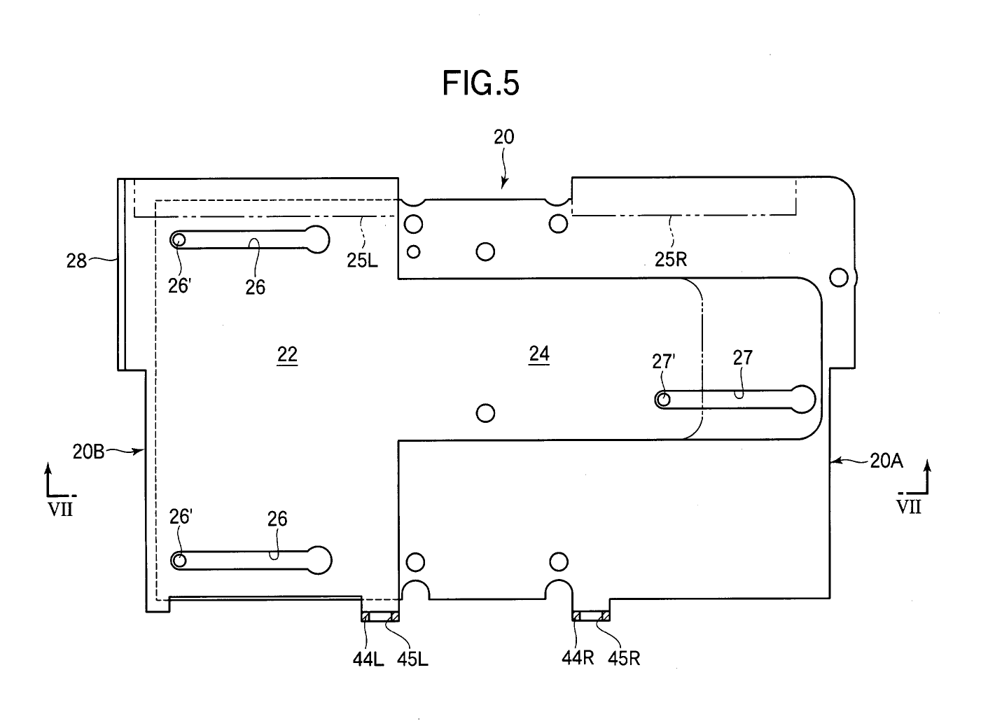

To perform the interpupillary distance adjusting operation and the focusing operation described above, an optical system mount plate 20 shown in FIG. 5 is provided on a bottom side of the casing 10. Note that, in FIGS. 1 and 3, the optical system mount plate 20 is omitted for the simplicity of the drawings.

The optical system mount plate 20 is composed of a rectangular plate 20A, fixed to the main casing section 10A, and a slide plate 20B slidably disposed on the rectangular plate 20A and fixed to the movable casing section 10B. The rectangular plate 20A and the slide plate 20B are made of appropriate metal material, preferably, light metal, such as aluminum or aluminum alloy.

The slide plate 20B has a rectangular portion 22, having approximately the same breadth as the rectangular plate 20A, and an extending portion 24, integrally connected to and extending rightward from the rectangular portion 22. The attaching base 19R of the lens barrel 17R is fixed at a predetermined position on the rectangular plate 20A, and the attaching base 19L of the lens barrel 17L is fixed at a predetermined position on the rectangular portion 22 of the rectangular plate 20B. Note that, in FIG. 5, the fixed position of the attaching base 19R of the lens barrel 17R is indicated as an area enclosed by chain double-dashed line 25R, and the fixed position of the attaching base 19L of the lens barrel 17L is indicated as an area enclosed by chain double-dashed line 25L.

A pair of guide slots 26 are formed in the rectangular portion 22 of the slide plate 20B, and another guide slot 27 is formed in the extending portion 24. A pair of guide pins 26′, slidably engaged with the guide slots 26, and guide pin 27′, slidably engaged with the guide slot 27, are fixed on the rectangular plate 20A. The guide slots 26 and 27 are parallel to each other, and extend in the right and left direction by the same length. The length of each of the guide slots 26 and 27 corresponds to a movable distance of the movable casing section 10B relative to the main casing section 10A, i.e., the distance between the retracted position of the movable casing section 10B (FIGS. 1 and 2) and the maximum-extended position of the movable casing section 10B (FIGS. 3 and 4).

As understood from FIGS. 2 and 4, the optical system mount plate 20 is placed in the casing 10, and separated from the bottom of the casing 10 to form a space therein. The rectangular plate 20A is fixed to the main casing section 10A, and the slide plate 20B is fixed to the movable casing section 10B. Note that, for fixing the slide plate 20B to the movable casing section 10B, a flange 28, extending along the left side edge of the rectangular portion 22, is provided, and fixed on a partition 29 formed in the movable casing section 10B.

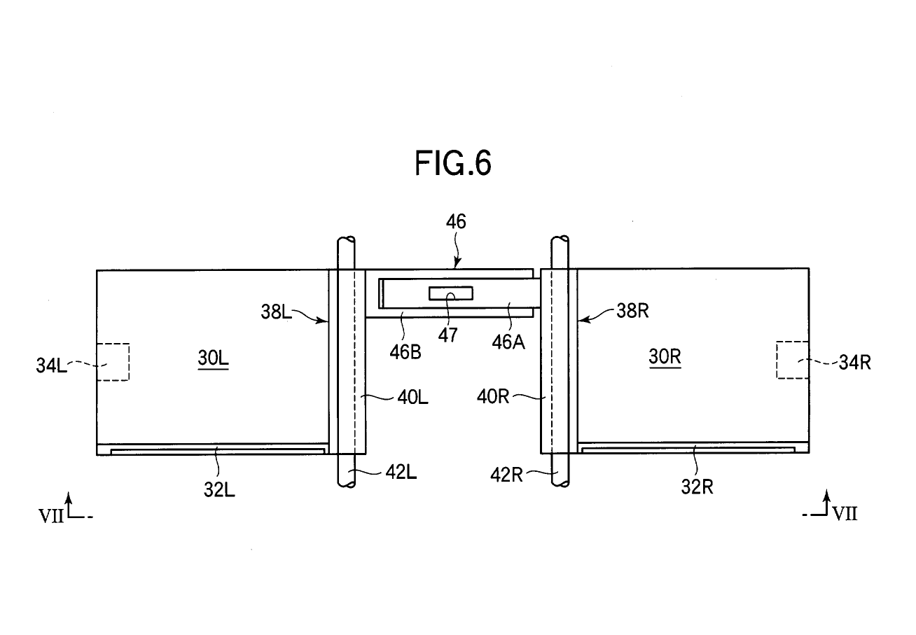

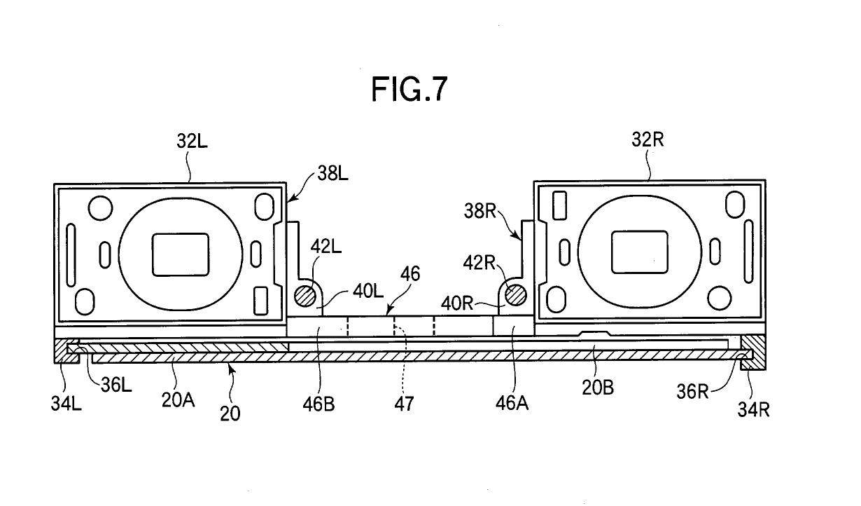

FIGS. 6 and 7 show a right mount plate 30R and a left mount plate 30L. The right mount plate 30R is provided for mounting the erecting prism system 14R of the right telescopic optical system 12R, and the left mount plate 30L is provided for mounting the erecting prism system 14L of the left telescopic optical system 12L. Upright plates 32R and 32L are provided along the rear peripheries of the right and left mount plates 30R and 30L. As shown in FIGS. 1 and 3, the right ocular lens system 15R is attached to the upright plate 32R, and the left ocular lens system 15L is attached to the upright plate 32L.

As shown in FIGS. 6 and 7, the right mount plate 30R is provided with a guide shoe 34R secured to the underside thereof in the vicinity of the right side edge thereof. The guide shoe 34R is formed with a groove 36R, which slidably receives a right side edge of the rectangular plate 20A, as shown in FIG. 7. Similarly, the left mount plate 30L is provided with a guide shoe 34L secured to the underside thereof in the vicinity of the left side edge thereof. The guide shoe 34L is formed with a groove 36L, which slidably receives a right side edge of the rectangular plate 20B, as shown in FIG. 7.

Note that since FIG. 7 is a sectional view along line VII-VII of FIG. 6, the optical system mount plate 20 should not be indicated in FIG. 7. Nevertheless, for the simplicity of the explanation, in FIG. 7, the optical system mount plate 20 is indicated as a section along line VII-VII of FIG. 5, and the, guide shoes 34R and 34L are indicated as sectional views.

As shown in FIGS. 6 and 7, the right mount plate 30R has a side wall 38R provided along a left side edge thereof, and a lower portion of the side wall 38R is formed as a swollen portion 40R having a through bore for slidably receiving a guide rod 42R. The front end of the guide rod 42R is inserted in a hole 43R formed in the inside attaching portion 19R′ of the attaching base 19R, and is fixed thereto. The rear end of the guide rod 42R is inserted in a hole 45R formed in an upright fragment 44R integrally formed on a rear edge of the rectangular plate 20A, and is fixed thereto (see FIG. 5). Note that, in FIG. 5, the upright fragment 44R is indicated as a sectional view so that the hole 45R is observed, and in FIGS. 1 and 3, the rear end of the guide rod 42R is inserted in the hole 45R of the upright fragment 44R.

Similarly, the left mount plate 30L has a side wall 38L provided along a right side edge thereof, and a lower portion of the side wall 38L is formed as a swollen portion 40L having a through bore for slidably receiving a guide rod 42L. The front end of the guide rod 42L is inserted in a hole 43L formed in the inside attaching portion 19L′ of the attaching base 19L, and is fixed thereto. The rear end of the guide rod 42L is inserted in a hole 45L formed in an upright fragment 44L integrally formed on a rear edge of the rectangular plate 20B, and is fixed thereto. Note that, similarly to the upright fragment 44R, in FIG. 5, the upright fragment 44L is indicated as a sectional view so that the hole 45L is observed, and in FIGS. 1 and 3, the rear end of the guide rod 42L is inserted in the hole 45L of the upright fragment 44L.

The objective lens system 13R of the right telescopic optical system 12R is disposed at a stationary position in front of the right mount plate 30R. Therefore, when the right mount plate 30R is moved back and forth along the guide rod 42R, the distance between the objective lens system 13R and the erecting prism system 14R is adjusted, so that a focusing operation of the right telescopic optical system 12R is performed. Similarly, since the objective lens system 13L of the left telescopic optical system 12L is disposed at a stationary position in front of the left mount plate 30L, by moving the left mount plate 30L back and forth along the guide rod 42L, the distance between the objective lens system 13L and the erecting prism system 14L is adjusted, so that a focusing operation of the left telescopic optical system 12L is performed.

In order to simultaneously move the right and left mount plates 30R and 30L along the guide rods 42r and 42L such that a distance between the right and left mount plates 30R and 30L is variable, the mount plates 30R and 30L are interconnected to each other by an expandable coupler 46, as shown in FIGS. 5 and 6.

In particular, the expandable coupler 46 includes a rectangular lumber-like member 46A, and a forked member 46B in which the lumber-like member 46A is slidably received. The lumber-like member 46A is securely attached to the underside of the swollen portion 40R of the side wall 38R at the forward end thereof, and the forked member 46B is securely attached to the underside of the swollen portion 40L of the side wall 38L at the forward end thereof. Both members 46A and 46B have a length which is greater than the distance of movement of the movable casing section 10B, between its retracted position (FIGS. 1 and 2) and its maximum extended position (FIGS. 3 and 4). Namely, even though the movable casing section 10B is extended from the retracted position to the maximum extended position, slidable engagement is maintained between the members 46A and 46B.

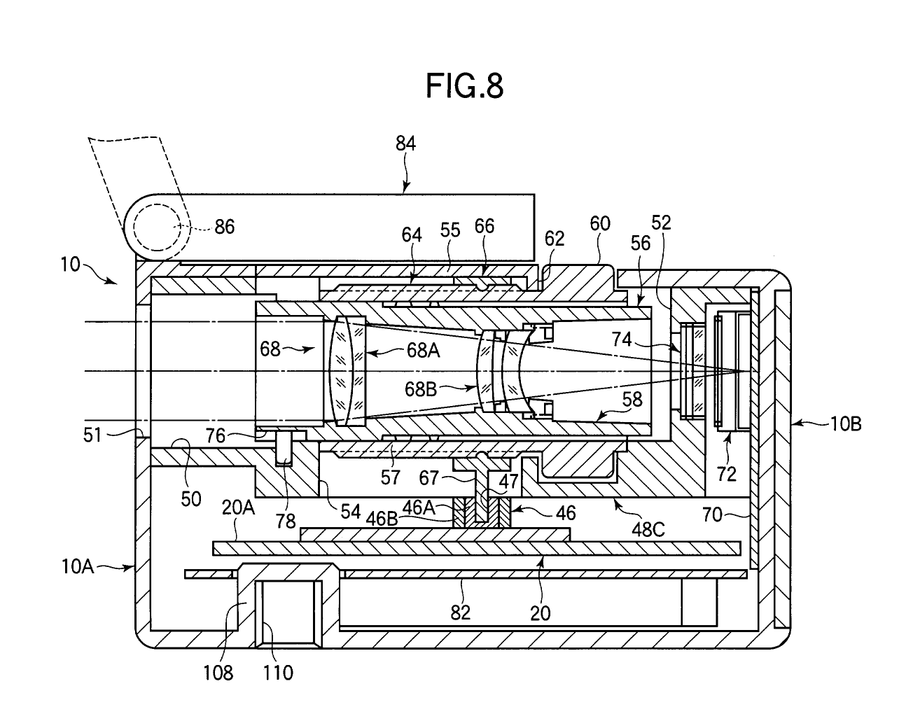

With reference to FIG. 8, there is shown a vertical sectional view along line VIII-VIII of FIG. 1. As understood from FIGS. 2, 4, and 8, an inner frame 48 is housed in the casing 10, and is fixed to the main casing section 10A and the rectangular plate 20A. The inner frame 48 has a central portion 48C, a right wing portion 48R extending from the central portion 48C rightward, a vertical wall 48S extending from a right periphery of the right wing portion 48R downward, and a left wing portion 48L extending from the central portion 48C leftward.

As shown in FIG. 8, a bore 50 is formed in a front end portion of the central portion 48C, and is aligned with a circular window 51 formed in a front wall of the main casing section 10A. A recess 52 is formed in a rear portion in the central portion 48C, and a rectangular opening 54 is formed in a bottom of the recess 52. A top wall of the main casing section 10A is provided with an opening for exposing the recess 52, and the opening is closed by a cover plate 55 which can be removed from the opening.

A tubular assembly 56 is assembled in the recess 52 while the cover plate 55 is removed. The tubular assembly 56 has a rotary wheel cylinder 57 and a lens barrel 58 disposed coaxially in the rotary wheel cylinder 57. The rotary wheel cylinder 57 is rotatably supported in the recess 52, and the lens barrel 58 can be moved along the central axis thereof while the lens barrel 58 is kept still so as not to rotate about the central axis. After assembling the tubular assembly 56, the cover plate 55 is fixed to cover the recess 52. A rotary wheel 60 is provided on the rotary wheel cylinder 57. The rotary wheel 60 has an annular projection formed on an outer surface of the rotary wheel cylinder 57, and the rotary wheel 60 exposes outside the top wall of the main casing section 10A through an opening 62 formed in the cover plate 55.

Helicoids 64 are formed on an outer surface of the rotary wheel cylinder 57, and an annular member 66 is threadingly fit on the helicoids 64. Namely, a plurality of projections engaged with the helicoids 64 of the rotary wheel cylinder 57, are formed on an inner wall of the annular member 66, and disposed at a constant interval. A flat surface is formed on an outer periphery of the annular member 66, and is slidably engaged with an inner wall of the cover plate 55. Namely, when the rotary wheel cylinder 57 is rotated, the annular member 66 is not rotated due to the engagement of the flat surface and the inner wall of the cover plate 55, and is kept in a non-rotational state. Thus, when the rotary wheel cylinder 57 is rotated, the annular member 66 is moved along the central axis of the rotary wheel cylinder 57 due to the threading contact with the helicoids 64, and the moving direction depends on the rotational direction of the rotary wheel cylinder 57.

A tongue 67 is projected from the annular member 66, and is positioned at an opposite side of the flat surface of the annular member 66. As shown in FIG. 8, the tongue 67 is projected from the rectangular opening 54 of the central portion 48C, and is inserted in a hole 47 formed in the rod member 46A. Therefore, when a user rotates the rotary wheel cylinder 57 by contacting the exposed portion of the rotary wheel 60 with a finger, for example, the annular member 66 is moved along the central axis of the rotary wheel cylinder 57, as described above, so that the mount plates 30R and 30L are moved along the optical axes of the telescopic optical systems 12R and 12L. Thus, the rotational movement of the rotary wheel 60 is transformed into linear movements of the erecting prism systems 14R and 14L, and the ocular lens systems 15R and 15L, so that the telescopic optical systems 12R and 12L can be focused.

In this embodiment, the pair of telescopic optical systems 12R and 12L are designed, for example, in such a manner that, when the distance from each of the erecting prism systems 14R and 14L, and the ocular lens systems 15R and 15L to each of the objective lens systems 13R and 13L is the shortest, the pair of telescopic optical systems 12R and 12L focus on an object located at a distance between 40 meters ahead of the binocular telescope and infinity, and when observing an object between 2 meters and 40 meters ahead of the binocular telescope, the erecting prism systems and the ocular lens systems are separated from the objective lens systems so as to focus on the object. Namely, when the erecting prism systems are separated from the objective lens systems by the maximum distance, the pair of telescopic optical systems focus on an object located at a distance approximately 2 meters ahead of the binocular telescope.

A photographing optical system 68 is provided in the lens barrel 58, which is coaxially disposed in the rotary wheel cylinder 57. The photographing optical system 68 has a first lens group 68A and a second lens group 68B. A circuit board 70 is attached on an inner surface of a rear end wall of the main casing section 10A. A solid-state imaging device such as a CCD 72 is mounted on the circuit board 70, and a light-receiving surface of the CCD 72 is aligned with the photographing optical system 68. An opening is formed in a rear end portion of the central portion 48C of the inner frame 48, and is aligned with the optical axis of the photographing optical system 68. An optical low-pass filter 74 is fit in the opening. Thus, the binocular telescope of this embodiment has the same photographing function as a digital camera, so that an object image obtained by the photographing optical system 68 is formed on the light-receiving surface of the CCD 72 as an optical image, which is photoelectrically converted into one frame's worth of image signals.

In FIGS. 1 through 4, the optical axis of the photographing optical system 68 is indicated by the reference OS, and the optical axes of the right and left telescopic optical systems 12R and 12L are indicated by references OR and OL. The optical axes OR and OL are parallel to each other, and to the optical axis OS of the photographing optical system 68. As shown in FIGS. 2 and 4, the optical axes OR and OL define a plane P which is parallel to the optical axis OS of the photographing optical system 68. The right and left telescopic optical systems 12R and 12L can be moved parallel to the plane P, so that the distance between the optical axes OR and OL, i.e., the interpupillary distance, can be adjusted.

When the photographing optical system 68 is constructed to be able to perform pan-focus photography in which the photographing optical system 68 focuses an object including a near object, which is situated at a predetermined distance ahead of the binocular telescope, and an object at infinity, and a photographing operation is performed only in the pan-focus photography, a focusing mechanism does not need to be mounted in the lens barrel 58. However, when the binocular telescope is required to photograph a near object, which is situated less than 2 meters ahead of the binocular telescope similarly to a usual camera, the lens barrel 58 needs to be provided with a focusing mechanism.

Therefore, a female screw is formed on an inner wall of the rotary wheel cylinder 57, and a male screw, engaged with the female screw of the rotary wheel cylinder 57, is formed on an outer wall of the lens barrel 58. The front end of the lens barrel 58 is inserted in the bore 50, and a bottom portion of the front end is formed with a key groove 76, which extends from the front end of the lens barrel 58 in the longitudinal direction by a predetermined length. A hole is formed in a bottom portion of the front end of the inner frame 48, and a pin 78 is planted in the hole to engage with the key groove 76. Thus, by the engagement of the key groove 76 and the pin 78, the rotation of the lens barrel 58 is prevented.

Therefore, when the rotary wheel cylinder 57 is rotated by an operation of the rotary wheel 60, the lens barrel 58 is moved along the optical axis of the photographing optical system 68. Thus, the female screw formed on the inner wall of the rotary wheel cylinder 57 and the male screw formed on the outer wall of the lens barrel 58 form a movement-conversion mechanism that converts a rotational movement of the rotary wheel 57 into a linear movement or focusing movement of the lens barrel 58.

Helicoids 64 formed on the outer wall of the rotary wheel cylinder 57 and the female screw formed on the inner wall of the rotary wheel cylinder 57 are inclined in the opposite direction to each other so that, when the rotary wheel cylinder 57 is rotated in such a manner that the erecting prism systems 14R and 14L and the ocular lens systems 15R and 15L are separated from the objective lens systems 13R and 13L, the lens barrel 58 is moved to separate from the CCD 72. Due to this, an image of a near object can be focused on the light-receiving surface of the CCD 72. The pitch of the helicoids 64 and the pitch of the female screw of the inner wall are different from each other in accordance with the optical characteristics of the pair of telescopic optical systems 12R and 12L and the photographing optical system 68.

As shown in FIGS. 1 through 4, a power supply circuit board 80 is provided in a right end portion of the main casing section 10A. As shown in FIGS. 2, 4, and 8, a control circuit board 82 is provided between the bottom of the main casing section 10A and the optical system mount plate 20, and is fixed on the bottom. Electronic parts such as a CPU, a DSP, a memory, a capacitor, and soon are mounted on the control circuit board 82, and the circuit board 70 and the power supply circuit board 80 are connected to the control circuit board 82 through a flat flexible wiring cord (not shown).

In the embodiment, as shown in FIGS. 2, 4, and 8, an LCD monitor 84 is disposed on an upper surface of the top wall of the main casing section 10A. The LCD monitor 84 has a flat rectangular plate shape. The LCD monitor 84 is arranged in such a manner that its front and rear sides, positioned at opposite sides, are perpendicular to the optical axis of the photographing optical system 68, and the LCD monitor 84 is rotatable about a rotational shaft 86 provided along the front side. The LCD monitor 84 is usually folded or closed as shown by a solid line in FIG. 8. In this condition, since the display surface of the LCD monitor 84 faces an upper surface of the main casing section 10A, the display surface cannot be seen. Conversely, when a photographing operation is performed using the CCD 72, the LCD monitor 84 is rotated and raised from the folding position to a display position shown by a broken line in FIG. 8, so that the display surface of the LCD monitor 84 can be seen from the side of the ocular lens systems 15R and 15L.

The left end portion of the movable casing section 10B is divided by the partition 29, to form a battery chamber 88 in which batteries 92 are housed. As shown in FIGS. 2 and 4 a lid 90 is provided in a bottom wall of the battery chamber 88. By opening the lid 90, the batteries 92 can be mounted in or removed from the battery chamber 88. The lid 90 forms a part of the movable casing section 10B, and is fixed at a closing position shown in FIGS. 2 and 4 through a proper engaging mechanism.

The weight of the power supply circuit board 80 is relatively high, and similarly, the weights of the batteries 92 are relatively high. In the embodiment, two components having a relatively large weight are disposed in the both ends of the casing 10. Therefore, the weight balance of the binocular telescope with a photographing function is improved.

As shown in FIGS. 1 and 3, electrode plates 94 and 96 are provided at front and rear portions of the battery chamber 88. The batteries 92 are arranged in parallel to each other in the battery chamber 88, and directed in the opposite directions in the battery chamber to contact the electrode plates 94 and 96. The electrode plate 94 is electrically connected to the casing 10, and the electrode plate 96 is electrically connected to the power supply circuit board 80 through a power source cable (not shown) so that electric power is supplied from the batteries 92 to the power supply circuit board 80. The power supply circuit board 80 supplies electric power to the CCD 72 mounted on the circuit board 70, the electric parts such as the microcomputer and the memory mounted on the control circuit board 82, and the LCD monitor 84.

As shown in FIG. 1 through FIG. 4, it is possible to provide a video output terminal 102, for example, as an external connector, on the power supply circuit board 80, and in this case, a hole 104 is formed in the front wall of the main casing section 10A so that an external connector is connected to the video output terminal 102. Further, as shown in FIGS. 2 and 3, a CF-card driver 106, in which a CF-card can be detachably mounted as a memory card, may be provided below the control circuit board 82 on the bottom of the main casing section 10A.

As shown in FIGS. 2, 4, and 8, a screw hole forming part 108 is integrally formed on a bottom of the main casing section 10A. The screw hole forming part 108 is a thick portion having a circular section, and a screw hole 110, opening to an outer surface of the bottom, is formed in the thick portion. The screw hole 110 of the screw hole forming part 108 is connected to a screw attached to a tripod head.

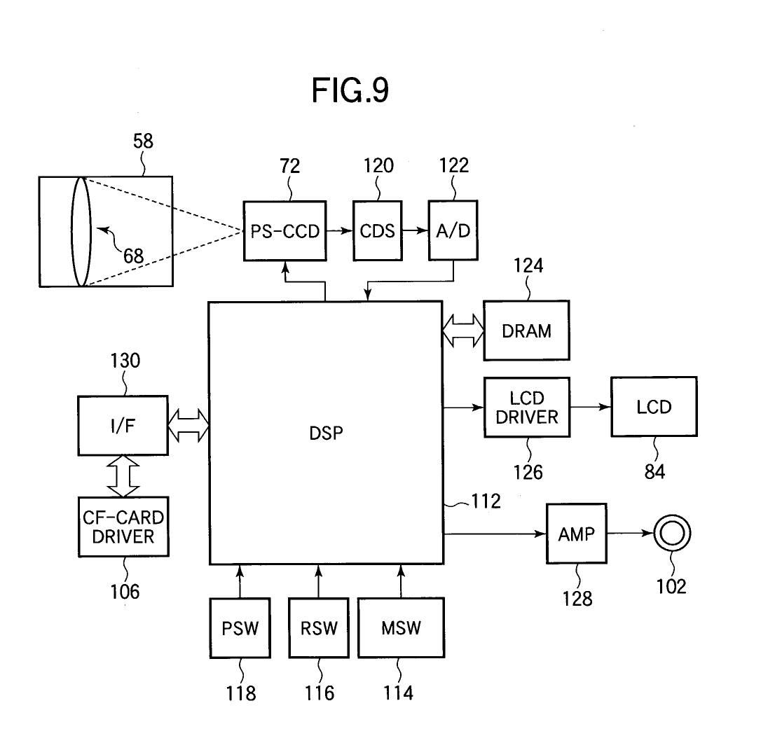

FIG. 9 is a block diagram showing a control circuit mounted on the control circuit board 82. A digital signal processing (DSP) circuit 112 has a microcomputer, by which the binocular telescope is controlled as a whole. In FIG. 9, the photographing optical system 68 is schematically indicated, and the lens barrel 58, in which the photographing lens system 68 is housed, is shown as a block. The CCD 72, the LCD monitor 84, and the CF-card driver 106 are also shown as blocks, and the video output terminal 102 is schematically indicated.

In the embodiment, the CCD (PS-CCD) 72 is a progressive-scan type CCD, i.e., of a type which outputs one frame's worth of image signals in the progressive-scan method. In other words, a CCD, using an image signal reading method other than the progressive-scan method (the interlace scan method, for example), is not used.

As is well known, in CCDs using either the progressive scan method or the interlace scan method, a lot of photodiodes are arranged in a matrix on a light-receiving surface of the CCD 72, and a vertical transfer path is provided adjacent to each vertical line of photodiodes. A horizontal transfer path is connected to the end portions of all of the vertical transfer paths. When an optical image is formed on the light-receiving surface of the CCD 72, an electric charge is accumulated in each of the photodiodes. The amount of accumulated electric charge depends upon the amount of received light, and the accumulated electric charge corresponds to a pixel signal.

In the progressive scan method, all of the accumulated electric charges are simultaneously shifted to the corresponding vertical transfer path, and then transferred to the horizontal transfer path along the vertical transfer path one horizontal line at a time, so that one horizontal line's worth of image signals is output from the horizontal transfer path. Conversely, in the interlace scan method, electric charges are shifted from odd number lines of photodiodes, for example, to the corresponding vertical transfer path, and then transferred to the horizontal transfer path along the vertical transfer path one horizontal line at a time, so that an image signal of one horizontal line's worth is output from the horizontal transfer path. When the reading operation of the odd number lines of photodiodes has been completed, electric charges generated in even number lines of photodiodes are read similarly.

Thus, since, in the progressive scan method, one frame's worth of image signals is simultaneously shifted to the vertical transfer path, the one frame's worth of image signals has constant image information with respect to a movement or time change of the object. Conversely, in the interlace scan method, the shift of image signals of the even number field to the vertical transfer path is delayed relative to the shift of image signals of the odd number field to the vertical transfer path by a predetermined period of time. Therefore, an exposure time (i.e., electric charge time) for the image signal of the even number field is longer by the delayed time. As a result, a time difference occurs between the image information which comes from the image signals of the odd number field and the image information which comes from the image signal of the even number field, so that an image trembling, i.e., deterioration of the reproduced image, obtained from the image signals of the odd number field and the even number field, will occur. The faster the object moves, the more remarkable the image deterioration.

If a CCD using the interlace scan method, is utilized, and the time difference, in the image information for the image signals of the odd number field and the image information for the image signals of the even number field, is to be removed, a mechanical shutter needs to be provided for the CCD. Namely, an exposure time (i.e., electric charge accumulation time) for the CCD is controlled by the mechanical shutter, and the mechanical shutter is closed while both fields of image signals are read out from the CCD, so that the time difference is removed.

However, for assembling the mechanical shutter for the CCD, a large space is necessary, which causes the problem of bulkiness in a binocular telescope with a photographing function. Further, if the mechanical shutter is to be controlled at a high speed with high accuracy, the cost of the mechanical shutter will be high, and the structure will become large. Therefore, it would be impossible to assemble the mechanical shutter in a binocular telescope with a photographing function, in which the distance between the optical axes of the pair of telescopic optical systems 12R and 12L is about 50 mm when the movable casing section 10B is pushed into-the main casing section 10A.

Accordingly, as described above, in the embodiment, since a CCD 72 using the progressive scan method is utilized, it is not necessary to assemble the mechanical shutter in the CCD 72, so that the manufacturing cost of the binocular telescope with a photographing function can be reduced. Further, for the CCD 72 using the progressive scan method, the exposure time (electric charge accumulation time) is electronically controlled, which is called an electronic shutter. Due to the electronic shutter, a high-speed shutter operation such as 1/2000-1/10000 sec, which is difficult for a mechanical shutter to perform, can be performed with high accuracy. Therefore, the aperture value of the photographing optical system 68 is set to a small value (i.e., brighter), or a gain of the image signal (corresponding to ISO sensitivity in a silver halide film) is raised, so that the digital camera of the binocular telescope with a photographing function can perform a photographing operation without being significantly affected by a camera shake.

In FIG. 9, a mode selection switch (MSW) 114, a release switch (SWR), and a picture selection switch (PSW) 118, which are provided on an upper surface of the main casing section 10A, are connected to the digital signal processing circuit 112. A power switch (not shown) is provided, and the switches 114, 116, and 118 are actuated by turning ON the power switch.

The mode selection switch 114 is provided for selecting various kinds of operation modes. When a record mode is selected by the mode selection switch 114, the CCD 72 is actuated, so that an output of an image signal from the CCD 72 is started. Namely, the image signal is read out form the CCD 72 in accordance with a drive pulse output by a CCD drive circuit provided in the DSP 112.

The image signal output from the CCD 72 is sample-held by a correlated double sampling circuit (CDS) 120, and A/D-converted to a digital image signal by an A/D-converter 122. The digital image signal is input to the DSP 112, where the digital image signal is subjected to image process such as a gamma correction and a black-level correction. The digital image signal is stored in a dynamic RAM (DRAM) 124, for example, which is a large capacity external memory which is writable and readable. The DSP 112 calculates a next exposure time (i.e., electric charge accumulation time) for the CCD 72 based on the brightness of one frame's worth of digital image signals, every time one frame's worth of digital image signals is written in the DRAM 124. Namely, the reading period for the one frame's worth of image signals from the CCD 72 is varied in accordance with the brightness of the object. Therefore, the CCD 72 is always properly exposed to generate high-quality image signals. Note that the one frame's worth of digital image signals stored in the DRAM 124 is overwritten by one frame's worth of digital image signals obtained in the next process.

On the other hand, the DSP 112 reads one frame's worth of digital image signals from the DRAM 124 at a predetermined time interval (30 times a second in the NTSC color system, for example), and the digital image signal is subjected to a thinning process to obtain reduced-image data. In the DSP 112, a video signal of an image to be displayed on the LCD monitor 84 is generated based on the reduced-image data. The video signal is output to an LCD driver 126, so that an object image is reproduced and indicated by the LCD monitor 84. Further, in the DSP 112, a composite video signal is generated based on the reduced-image data, and output to an external device through an amplifier 128 and the video output terminal 102. Namely, an object image formed by the photographing optical system 68 can be indicated by a TV monitor, if necessary.

As described above, when the record mode is selected by the mode selection switch 114, the object image is indicated by the LCD monitor 84 as a moving picture. During the record mode, when the release switch 116 is turned ON, the DSP 112 reads one frame's worth of digital image signals from the DRAM 124, an optimum exposure time (i.e., optimum electric charge accumulation time) is calculated based on the brightness of the digital image signal, and an electric charge discharging signal is output to the CCD 72. Due to this, accumulated electric charges are discharged from all the photodiodes of the CCD 72, and right after this, an exposure is started to photograph a still image.

After the optimum electric charge accumulation time has passed, since the start of the exposure, one frame's worth of an image signals is read out from the CCD 72, subjected to the image process as described above, and stored in the DRAM 124. After the completion of this storing process, a writing operation of a digital image signal to the DRAM 124 is prohibited for a predetermined period (5 seconds, for example). Namely, although a reading operation of an image signal from the CCD 72 is restarted after the completion of the photographing operation of the still image, a digital image signal obtained based on the read image signal is not written in the DRAM 124 for the writing prohibiting period (i.e., 5 seconds), and is abandoned. Note that, since a video signal of an image, which is to be indicated by the LCD monitor 84, and a composite video signal are continuously carried out, the photographed image is indicated by the LCD monitor 84 and the TV monitor, as a still image, while the writing operation is prohibited.

While the writing operation is prohibited, the DSP 112 reads one frame s worth of digital image signals from the DRAM 124, and performs a predetermined image compression process according to JPEG, for example, on the digital image signal, to generate compressed image data. Further, in the DSP 112, the one frame's worth of digital image signals is thinned to generate reduced-image data (image data of a thumbnail size, for example). The compressed image data and the reduced-image data (or the thumbnail image data) are transferred to the CF-card driver 106 through an interface 130, and recorded in the CF-card in accordance with a predetermined format.

When a reproduction mode is selected by the mode selection switch 114, the DSP 112 controls the CF-card driver 106 to read all of the thumbnail image data and store them in the DRAM 124, so that the thumbnail images are indicated by the LCD monitor 84 based on the thumbnail image data recorded in the CF-card. The DSP 112 then calculates the size and the position of each of the thumbnail images based on the number of the thumbnail images, reads the thumbnail image data from the DRAM 124, and performs a thinning process on the thumbnail image data to generate a video signal. Thus, all of the thumbnail images are indicated on the LCD monitor 84 based on the thumbnail image data.

When one of the thumbnail images is selected by handling the picture selection switch 118 when the thumbnail images are indicated on the LCD monitor 84, the DSP 112 reads the compressed image data corresponding to the selected thumbnail image from the CF-card, performs an image data expansion process and an image data reproduction process, and writes the reproduced image data in the DRAM 124. The DSP 112 reads the reproduced image data from the DRAM 124, and performs a thinning process on the image data to generate a video signal, so that the desired image is indicated by the LCD monitor 84.

It is possible that the CF-card can be removed from the CF-card driver 106, and mounted in a computer having image reproduction ability, so that the compressed image data and thumbnail image data are subjected to predetermined processes.

Note that the present invention can be applied to a monocular telescope with a photographing function.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-106388 (filed on Apr. 9, 2002) which is expressly incorporated herein, by reference, in its entirety.

1. An observation optical device with a photographing function, comprising:
a photographing optical system that forms an image;
a telephoto observation optical system that can function as a view-finder optical system for said photographing optical system; and
a solid-state imaging device that photoelectrically converts said image into an image signal, and outputs said image signal in the progressive-scan method.

2. An observation optical device according to claim 1, wherein said telephoto observation optical system has a first part fixed at a predetermined position, and a second part movable along the optical axis of said telephoto observation optical system relative to said first part so that said telephoto observation optical system focuses, a rotary wheel cylinder, in which said photographing optical system is mounted, being disposed close to said telephoto observation optical system, a first focusing mechanism for converting a rotational movement of said rotary wheel cylinder into a linear movement of said second part so that said telephoto observation optical system focuses, being provided between said rotary wheel cylinder and said second part, a second focusing mechanism for converting a rotational movement of said rotary wheel cylinder into a linear movement of said photographing optical system so that said photographing optical system focuses on said solid-state imaging device, being provided between said rotary wheel cylinder and said photographing optical system.

3. An observation optical device according to claim 2, wherein said first part comprises an objective lens system, and said second part comprises an erecting prism system and an ocular lens system.

4. An observation optical device according to claim 2, wherein said telephoto observation optical system comprises a pair of telescopic optical systems, said rotary wheel cylinder being provided between said pair of telescopic optical systems.

5. An observation optical device according to claim 4, further comprising a casing in which said pair of telescopic optical systems is housed, said casing having first and second casing sections which are movable relative to each other, one of said pair of telescopic optical systems being housed in said first casing section, another of said pair of telescopic optical systems being housed in said second casing section, one of said first and second casing sections being moved relative to another of said first and second casing sections, so that the interpupillary distance is adjusted.

6. An observation optical device according to claim 5, wherein one of said first and second casing sections is slidably housed in another of said first and second casing sections, said first and second casing sections being moved relative to each other so that the optical axes of said pair of telescopic optical systems are moved in a common plane to adjust the interpupillary distance.
